(19) United States
(12) Patent Application Publication
(10) Pub. No.: US 2009/0220380 A1
(43) Pub. Date: Sep. 3, 2009

(54) Wireless electronic monitor for a container such as an aquarium and the like

(76) Inventor: Daniel Joel Brown, Carson City, NV (US)

Correspondence Address: Daniel J. Brown, 108 S Carson Meadow Dr, Carson City, NV, 89701, US

(21) Appl. No.: 12/074,289

(22) Filed: Mar. 1, 2008

(51) Int. Cl. B01J 19/00

(52) U.S. Cl. 422/68.1; 340/870.16

(57) ABSTRACT

A wireless electronic monitor for a container such as an aquarium is described. The apparatus comprises a sense and transmit assembly (STA) 15 configured with a pH sensor 6 submerged in the water inside the aquarium, and a receive and display assembly (RDA) 33 that displays the output of the sensor 6. A line-of-sight orientation is maintained between openings in each assembly using magnets to generate a clamping force on a transparent tank wall 16. A water test button 22 is pressed, and a single pulse of light travels from the RDA 33 to the STA 15. The single pulse of light turns the STA 15 on by closing a timed switch to the battery power. The pH sensor 6 output is converted to a train of frequency-modulated pulses of light that are transmitted back to the RDA 33. The frequency of the train of light pulses is determined by a CPU in the RDA 33, and assigned a pH value from calibration tables stored in electronic memory. The pH value is shown on a pH sensor output display 20 which can be manually placed anywhere on the tank wall by grasping the RDA 33 from the outside of the aquarium, and sliding the entire monitor to its desired location without getting wet hands. To fully realize a true monitor of the pH, the CPU in the RDA 33 is programmed to make periodic measurements of the pH by periodically emitting the single pulse of light to the STA 15. The results of each measurement are compared with upper and lower pH boundaries stored in an electronic memory. If a measurement is outside of a pre-determined range, the CPU activates an alarm speaker 28 and an alarm light 30.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to electronic sensing and monitoring devices, specifically a wireless electronic monitor of pH and the like for aquariums.

2. Prior Art

Previously, a pH measurement of water in a container such as an aquarium was done using colorimetry, a process wherein the color of an indicator chemical mixed with the water under test is compared with a chart that approximately correlates that color with a discrete value of pH. Colorimetry by its nature does not provide an output as a sensor that can be processed by electronic circuitry, and is therefore not a suitable sensor for a monitor that provides a warning when pH levels are outside of a desired range.

A combination electrode of the type available from Omega Engineering of Stamford, Conn. generates a voltage dependent on ionic activity in the water, can be configured to measure pH, and can operate continuously immersed in the water being tested. The combination electrode requires a meter to be useful, and a basic meter configuration includes a display of the pH or other ionic activity and some method to calibrate the electrode with standard solutions.

While the use of the combination electrode is ubiquitous in science and industry, it is not common in aquarium keeping and the like. Most typical pH measurement systems available from scientific instrument suppliers have a cable or wire and have a meter that either sets upon a benchtop or is mounted in an equipment panel. A notable exception is a handheld pH tester with the electrode and the display integrated into a compact and rugged field instrument. For a container such as a tank, the combination electrode typically penetrates the wall of the tank using a bulkhead fitting or similar to make a watertight connection. The combination electrode is not always connected directly to a meter with a coaxial cable. A transducer that converts the electrode output to a modulated current source is well known as a transmitter. Additionally, the combination electrode output can be sent through ambient air using radio waves or infrared light to a remote meter using prior art. Lastly, industrial process control applications commonly use a set-point monitor to provide a warning or alarm when the pH of a process is not within specified limits.

A limitation of using a typical electrode and meter is the coaxial cable or wire connecting the two.

A limitation of the typical meter and combination electrode is that there is no convenient surface to place it near a typical aquarium, or to mount the electrode. The typical scientific or industrial pH measurement equipment is not an aesthetically pleasing addition to the natural environment that an aquarium attempts to represent.

A limitation of a handheld pH test meter is that the typical design is intended for sampling applications, and has neither an intrinsic means of attachment to a tank or a set-point alarm that would make it a true monitor.

A limitation of measuring the pH of a liquid in a tank or container in most industrial applications is the requirement to penetrate the wall so that the combination electrode has access to the interior of the tank.

A limitation of using radio waves to transmit the output of the electrode to a meter is that the antenna attached to the transmitter must be kept above the surface of the liquid within the tank if the liquid is conductive, such as saltwater. This is due to the phenomena of attenuation of an electromagnetic field in a conductive fluid.

A limitation of the typical pH measurement system configured with a set-point monitor is again the industrial nature of the typical equipment available. A pH electrode would either have to penetrate the wall of the aquarium, or would have to be mounted to the lip around the edge, similar to how many aquarium heaters are attached. It is preferable to keep the electrode and the meter below the lip of the aquarium to avoid interference with the cover of the tank.

### OBJECTS AND ADVANTAGES

Accordingly, several objects and advantages of the present invention are:
1. to provide an automatic and periodic measurement of pH in a container such as an aquarium not possible with colorimetry;
2. to eliminate the use of a coaxial cable or wires between the pH sensor and the pH display;
3. to provide a small device that can be conveniently placed anywhere on any wall of an aquarium;
4. to eliminate the need to penetrate the wall of an aquarium or similar container;
5. to provide an efficient wireless transmittal of sensor output from within a salt water aquarium that cannot be blocked by objects within the aquarium;
6. to provide an alarm when the pH of an aquarium is outside of pre-determined limits; and
7. to obviate the need to personally test the water of an aquarium regularly.

Further objects and advantages are to provide a wireless pH monitor for aquariums that is simple to install and remove, provides an easy pH sensor replacement method, can be configured for remote monitoring, and can be configured for data logging of the pH sensor output. Still further objects and advantages of the present invention will become apparent from a consideration of the ensuing detailed description of the invention in conjunction with the accompanying drawings and the appended claims.

### SUMMARY

In accordance with the present invention a wireless electronic monitor for pH in an aquarium comprising two devices that sandwich a wall of the aquarium, the interior device transmitting the output of a pH sensor through the wall to the exterior device using frequency modulated pulses of light.

### DRAWINGS

### Figures

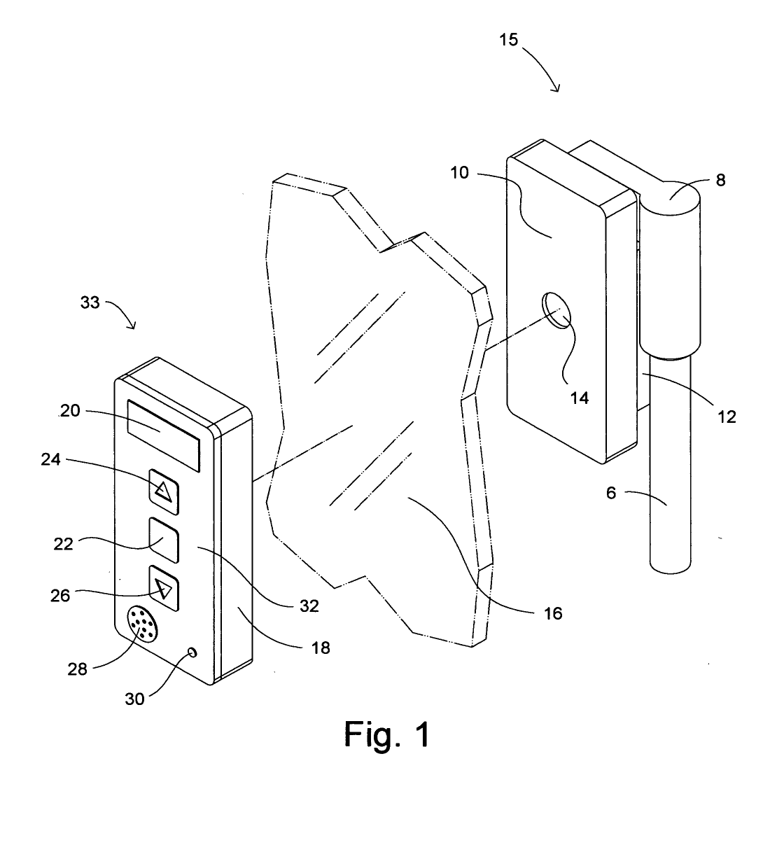

FIG. 1 shows a wireless electronic monitor in an exploded view demonstrating how it is used to sandwich a transparent aquarium wall.

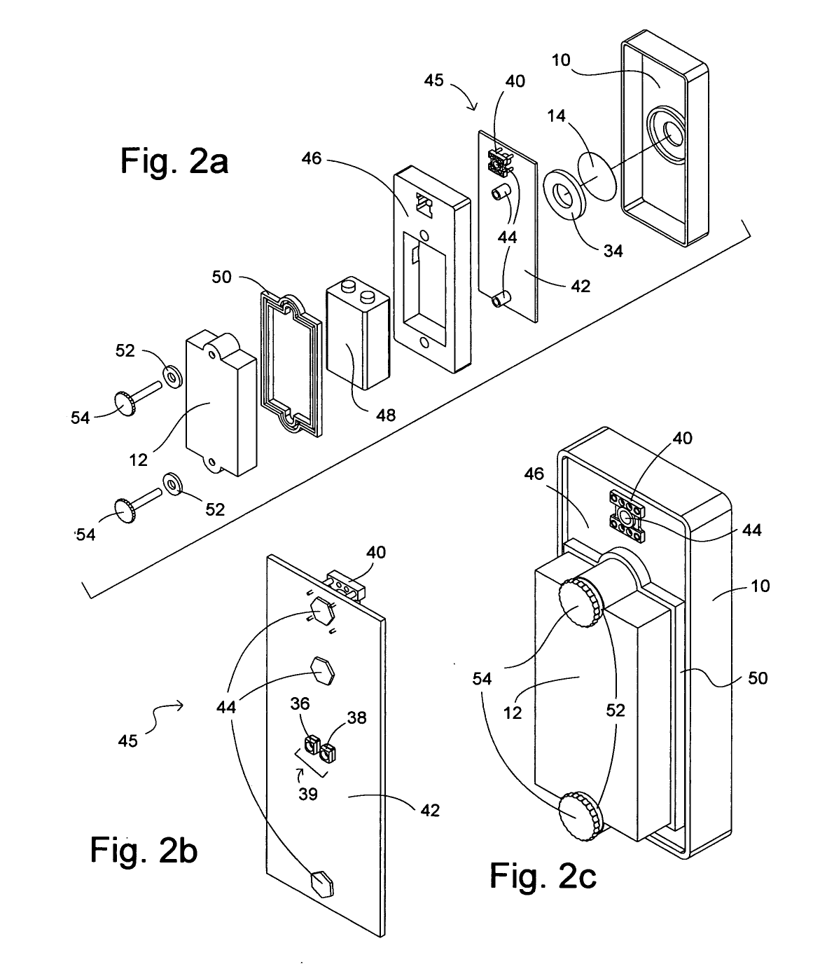

FIG. 2a to 2c show the components attached to the transmitter electronics housing.

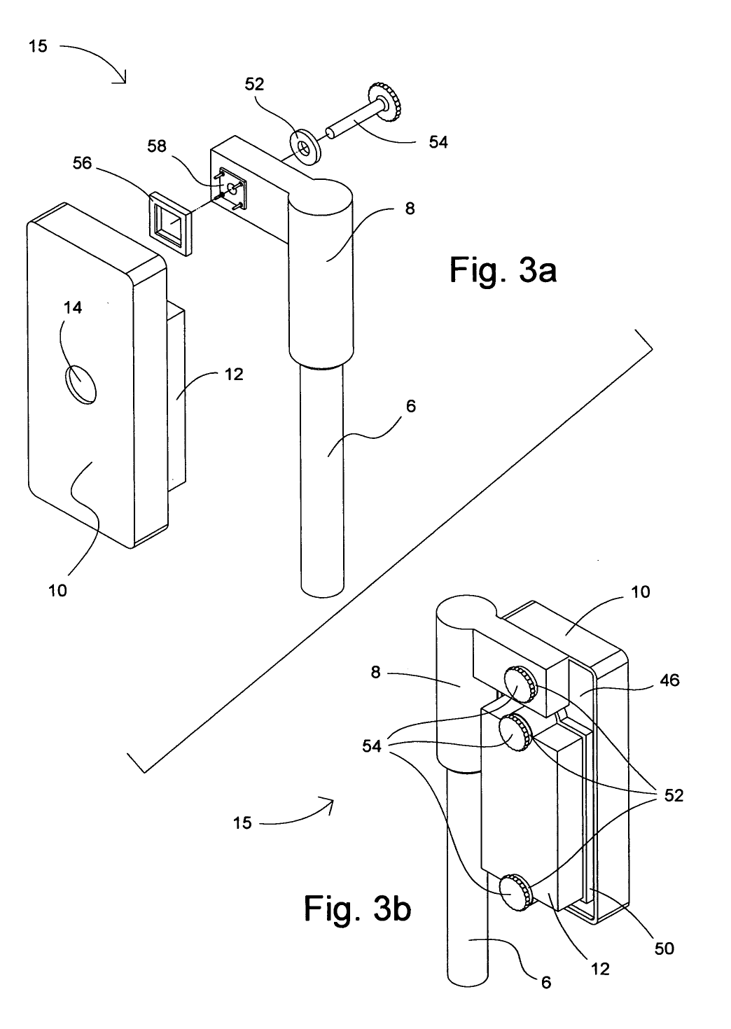

FIGS. 3a and 3b show the connection of the pH sensor to complete the sense and transmit assembly (STA).

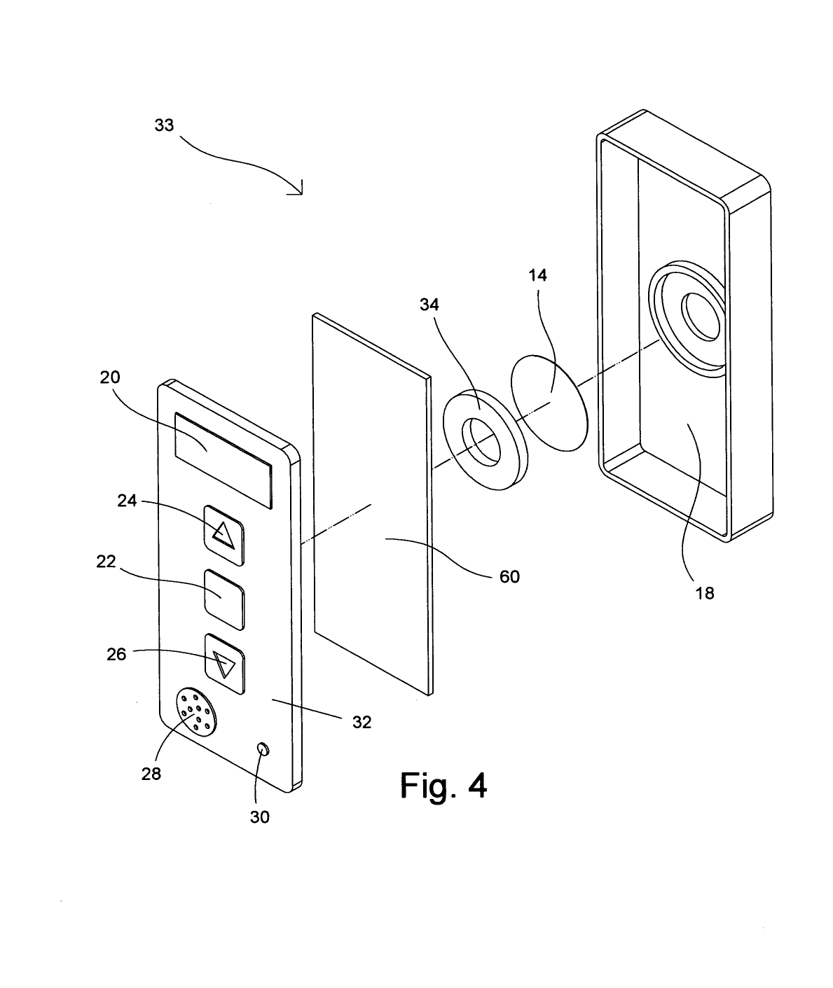

FIG. 4 shows the receive and display assembly (RDA) components that are attached to the receiver electronics housing.

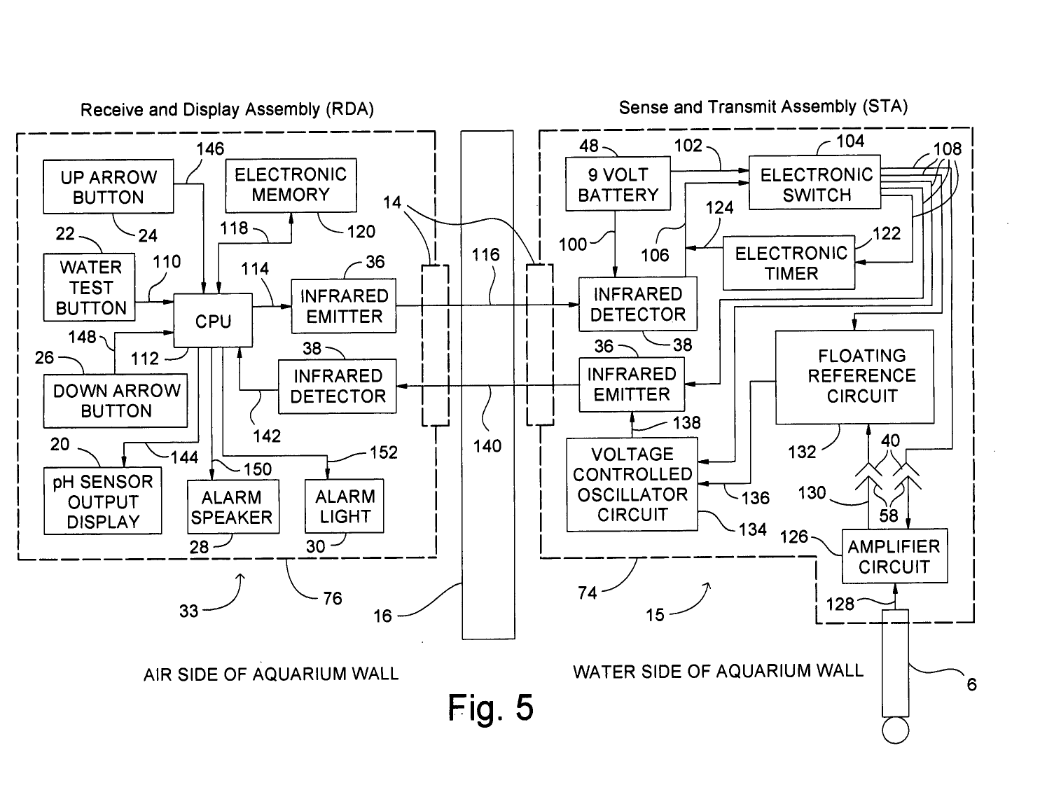

FIG. 5 shows a schematic representation of the wireless monitor configured for measuring pH in an aquarium.

### DRAWINGS

### Reference Numerals

6 pH Sensor
8 Molded Header
10 Transmitter Housing
12 Battery Cover
14 Transparent Window
15 Sense and Transmit Assembly (STA)
16 Transparent Tank Wall
18 Receiver Housing
20 pH Sensor Output Display
22 Water Test Button
24 Up Arrow Button
26 Down Arrow Button
28 Alarm Speaker
30 Alarm Light
32 Faceplate
33 Receive and Display Assembly (RDA)
34 Ring Magnet
36 Infrared Emitter
38 Infrared Detector
39 Infrared Emitter-Detector Pair
40 Electrical Socket Connector
42 Transmitter Circuit Board
44 Threaded Standoff
45 Transmitter Circuit Assembly
46 Potting Material
48 9 Volt Battery
50 Elastomer Battery Seal
52 Elastomer Washer
54 Thumbscrew
56 Elastomer Sensor Connection Seal
58 Electrical Pin Connector
60 Receiver Circuit Board
74 STA Waterproof Boundary
76 RDA Waterproof Boundary
100 Infrared Detector Power Supply
102 Electronic Switch Power Supply
104 Electronic Switch
106 Electronic Switch Input Voltage Level
108 pH Measurement Circuitry Power Supply
110 Manual pH Measurement Request
112 Central Processing Unit (CPU)
114 Single Voltage Pulse
116 Single Infrared Light Pulse
118 Automatic pH Measurement Request
120 Electronic Memory
122 Electronic Timer
124 Timer Output
126 Amplifier Circuit
128 pH Sensor Output
130 Amplifier Circuit Output
132 Floating Reference Circuit
134 Voltage Controlled Oscillator Circuit (VCO)
136 pH Modulated VCO Input Voltage
138 Train of Frequency Modulated Voltage Pulses
140 Train of Frequency Modulated Infrared Light Pulses
142 pH Modulated Frequency Signal
144 Digital pH Value
146 Increment Set-Point Signal
148 Decrement Set-Point Signal
150 Audible Alarm CPU Output
152 Visible Alarm CPU Output

### DETAILED DESCRIPTION

### FIGS. 1 Through 5-Preferred Embodiment

The detailed description set forth in connection with the appended drawings is intended as a description of presently preferred embodiments of the invention and is not intended to represent the only forms in which the present invention may be constructed and/or utilized. The description sets forth the functions and the sequence of steps for constructing and operating the invention in connection with the illustrated embodiments. However, it is understood that the same or equivalent functions and sequences may be accomplished by different embodiments that are also intended to be encompassed within the scope of the invention.

A preferred embodiment of the wireless electronic monitor for a container such as an aquarium is illustrated in FIG. 1 (exploded view). The monitor is comprised of a sense and transmit assembly (STA) 15 and a receive and display assembly (RDA) 33. The STA 15 is configured with a pH sensor 6 that is well known as a combination electrode of the type available from Omega Engineering Inc. of Stamford, Conn. However, any other device that exhibits a variable electrical output dependent upon aqueous ionic activity, dissolved gas concentration, or temperature and the like can be used as a transducer for the STA 15.

A molded header 8 is cast around the electrical connection end of the pH sensor 6 from a two-part polyurethane or epoxy resin that cures at approximately room temperature. The resin cannot be cured at elevated temperatures or generate significant exothermic heat during the cure because the pH sensor 6 contains air and aqueous solutions that can expand or boil. The header 8 is a watertight electrical and mechanical connection of the sensor 6 to power and signal processing circuits within a transmitter housing 10. In the preferred embodiment, the pH sensor 6 is detachable from the STA 15 so it can be easily replaced if broken or at the end of its operational life. The transmitter housing 10 and a battery cover 12 are both injection molded from a thermoplastic resin such as acrylonitrile butadiene styrene (ABS), polypropylene or the like. A transparent window 14 allows the transmission of light through an opening in the transmitter housing 10. The STA 15 is oriented to place the transparent window 14 against the interior side of a transparent wall 16. A similar opening (not shown) in a receiver housing 18 is aligned line-of-sight with the opening in the transmitter housing 10. The alignment of the two openings and the location of the wireless monitor on the tank wall 16 is maintained using magnetic clamping force on the wall between the STA 15 and the RDA 33.

As shown in FIG. 1, the preferred embodiment of the RDA 33 is configured with a pH sensor output display 20. A water test button 22 prolongs battery life by providing an on-demand measurement and display of pH. An up arrow button 24 and a down arrow button 26 permit set-point adjustments for the desired range of pH. If pH levels are outside of that range, an alarm speaker 28 and an alarm light 30 are activated. The RDA 33 is sealed from potential water spills during aquarium maintenance by a faceplate 32. The receiver housing 18 and the faceplate 32 of the preferred embodiment are molded from similar thermoplastic materials used for the transmitter housing 10 and the battery cover 12.

FIGS. 2a to 2c show the various components attached to the transmitter housing 10. As shown in FIG. 2a (exploded isometric view), the transparent window 14 is placed over the opening in the housing 10 and sealed watertight with silicone adhesive (not shown) or the like. A ring magnet 34 made of neodymium or similar high magnetic strength material of the type available from Master Magnetics, Inc. of Castle Rock, Colo. is placed on the window 14 and is mechanically attached to the housing 10 with epoxy adhesive (not shown) or the like. The housing 10 has a molded feature that assists aligning the window 14 and the magnet 34 with the opening in the housing 10. A transmitter circuit assembly 45 is attached to the magnet 34 with epoxy adhesive or the like. The transmitter housing 10 is then laid on a horizontal surface and filled with a potting material 46 such as polyurethane or silicone rubber to seal the transmitter circuit assembly 45.

As illustrated in FIG. 2b (isometric view), the transmitter circuit assembly 45 is partly comprised of an infrared emitter-detector pair 39, an electrical socket connector 40, and a transmitter circuit board 42. The transmitter circuit assembly 45 is configured to place the emitter-detector pair 39 within the center opening of the ring magnet 34 so that light can be emitted or detected through the transparent window 14. An infrared emitter 36, an infrared detector 38, and the socket connector 40 are well known electronic components of the type available from Digi-Key Corporation of Thief River Falls, Minn. Other electronic components comprising the transmitter circuit assembly 45 are not shown for clarity. A transmitter circuit board 42 is drilled with holes to create locations to insert a threaded stand-off 44 made of stainless steel or aluminum. As shown in FIG. 2c, the potting material 46 fills the transmitter housing 10 cavity to just below the openings in the stand-off 44 and the socket connector 40.

Referring to FIG. 2a, a rectangular recess is cast into the potting 46 by using a block of compliant material such as silicone rubber (not shown) to form the recess when the liquid potting 46 is dispensed or poured into the transmitter housing 10. After the potting material 46 hardens, the rubber block is removed, and a 9 volt battery 48 is placed in the recess and connected to the transmitter assembly 45 using a well known 9 volt battery connector (not shown). The battery 48 is kept dry using an elastomer battery seal 50 and an elastomer washer 52 molded from silicone rubber or the like. By hand tightening a plastic thumbscrew 54 into the threaded stand-off 44 at each end of the battery cover 12, the battery 48 is kept dry. The plastic thumbscrew 54 is designed to preferentially fail if over-tightened into the metal threaded stand-off 44.

FIGS. 3a (exploded isometric view) and 3b (isometric view) show the connection of the pH sensor 6 with the molded header 8 to the assembly shown in FIG. 2c. Referring to FIG. 3a, an elastomer sensor connection seal 56 is molded from silicone rubber or the like to seal the gap between the molded header 8 and the hardened potting material 46. An electrical pin connector 58 is partially encapsulated in the molded header 8 and inserted into the socket connector 40 openings (shown in FIG. 2c). By tightening a third thumbscrew 54 into a third threaded standoff 44 (shown in FIG. 2c), the seal 56 is compressed into the surface of the cured potting material 46. Another washer 52 maintains a waterproof seal of the socket connector 40 and the pin connector 58. FIG. 3b shows the fully assembled and sealed STA 15 ready to submerge in water.

As shown in FIG. 4 (exploded isometric view), the RDA 33 also contains the transparent window 14 and the ring magnet 34. Both are attached to a feature molded into the receiver housing 18 in a manner similar to the method used for the transmitter housing 10. A receiver circuit board 60 is configured with the emitter-detector pair 39 (not shown) and is mechanically attached to the ring magnet 34 with epoxy or similar adhesive. Other electronic components on the receiver circuit board 60 and the battery power supply for the RDA 33 are not shown for clarity.

Additionally, the preferred embodiment integrates the water test button 22, the up arrow button 24, and the down arrow button 26 into a well known membrane switch (not shown) of the type available from Nelson Nameplate of Los Angeles, Calif. The membrane switch is fabricated from laminated sheets of polyester or polycarbonate, to which conductive and colored inks are applied. Switches, light emitting diodes, regions of transparency for viewing underlying displays, and artwork can be combined into a very flat structure that is rugged and has low fabrication costs. The membrane switch is attached to the faceplate 32 typically using tape backed with acrylic adhesive or the like to provide a sealed keypad that is waterproof. Electrical contact of such a membrane switch to an electrical connection on the receiver circuit board 60 is typically done with a pigtail formed in the laminated sheets (not shown).

A schematic representation of the wireless monitor of pH for an aquarium is illustrated in FIG. 5. Clearly shown is the demarcation of the two main assemblies, with the STA 15 on the internal water side of the tank wall 16, and the RDA 33 on the external air side. An STA waterproof boundary 74 is formed around the electronics contained within the STA 15, leaving the water sensing end of the pH sensor 6 exposed to the water. Similarly, an RDA waterproof boundary 76 is formed around the electronics contained within the RDA 33.

FIG. 5 shows that the battery 48 provides an infrared detector power supply 100 to the infrared detector 38 contained in the STA 15. The battery 48 also provides an electronic switch power supply 102 to an electronic switch 104. When the infrared detector 38 is not illuminated above a set light threshold level, an electronic switch input voltage level 106 is configured to keep the switch 104 open. The open switch 104 prevents consumption of a pH measurement circuitry power supply 108 during periods of time when a pH measurement is not desired.

When a pH measurement is desired, FIG. 5 shows two methods by which it may be requested. Using the RDA 33, a manual pH measurement request 110 can be sent to a central processing unit (CPU) 112 by pressing the water test button 22. The CPU 112 sends a single voltage pulse 114 to the infrared emitter 36 within the RDA 33, causing it to emit a single infrared light pulse 116. An automatic pH measurement request 118 uses stored times or time periods accessed from an electronic memory 120 by the CPU 112 to initiate the single light pulse 116.

The single pulse of infrared light 116 transmits through the transparent window 14 in the RDA 33, through the transparent wall 16, through the transparent window 14 in the STM 15, and illuminates the infrared detector 38 within the STA 15. During the period that the detector 38 is illuminated by the light pulse 116, the switch input voltage level 106 is configured to close the open switch 104.

For the duration of the light pulse 116, the pH measurement circuitry power supply 108 is connected to an electronic timer 122 that self-starts immediately. A timer output 124 is connected to the switch input voltage level 106 to hold the switch 104 closed after the duration of the single light pulse 116 has elapsed, and will remain closed for the duration that the timer 122 is on. While the electronic timer 122 is on, the pH measurement power supply 108 is connected to the timer 122. When the timer 122 reaches the end of the specified on period, the timer output 124 is configured to open the switch 104 and eliminate its own power supply 108. The timer 122 will not re-start until the single infrared light pulse 116 requests another pH measurement.

During the period that the timer 122 is on, the pH measurement circuitry power supply 108 is turned on to the rest of the circuitry on the transmitter circuit assembly 45 (shown in FIG. 2b). In the preferred embodiment, an amplifier circuit 126 and the pH sensor 6 of FIG. 5 are placed close together and encapsulated in the molded header 8 (shown in FIGS. 3a and 3b). An amplifier circuit output 130 shown in FIG. 5 is connected to the transmitter circuit assembly 45 by the socket connector 40 (shown in FIGS. 2a to 2c), and the pin connector 58 (shown in FIG. 3a).

Referring again to FIG. 5, a floating reference circuit 132 places the reference potential for the pH sensor 6 and the amplifier circuit 126 at approximately 3 volts, or about one third of the 9 volt battery 48 potential. This is required because the pH sensor can be a positive or negative voltage. The gain of the amplifier 126 is configured so that negative voltage levels at the amplifier output 130 do not go more than about 2 volts below the reference potential for all expected values of pH to be measured. A voltage controlled oscillator circuit (VCO) 134 receives a pH modulated VCO input voltage 136 that will always be positive and indicative of the pH sensor output 128. By placing the reference potential at approximately 3 volts and limiting the amplifier output 130 to about plus or minus 2 volts relative to that reference, the battery 48 can be used when depleted to as low as 5 volts.

The VCO 134 converts the pH dependent VCO input voltage 136 into a train of frequency modulated voltage pulses 138. The voltage pulses 138 drive the infrared emitter 36 in the STA 15 to emit a train of frequency modulated light pulses 140. The light pulses 140 are transmitted through the transparent window 14 in the STA 15, the transparent tank wall 16, and the transparent window 14 in the RDA 33. The infrared detector 38 in the RDA 33 is illuminated by the train of light pulses 140 and generates a pH modulated frequency signal 142 that is sent to the CPU 112. The frequency of the signal 142 is compared with a calibration look-up table in the electronic memory 120 that is obtained by measuring the frequency of the pH modulated signal 142 when the pH sensor 6 is immersed into a standard solution of known pH for two or more pH values. A digital pH value 144 of the current pH within the tank is sent to the pH sensor output display 20 and provides a visible numeric pH value.

By using the up arrow button 24 and the down arrow button 26 to adjust upper and lower bounds for acceptable pH, set-point values are stored in the electronic memory 120. The ability to send an increment set-point signal 146 or a decrement set-point signal 148 to the CPU 112 permits adjustable alarm levels for aquarium pH. The CPU 112 is programmed to periodically make an automatic pH measurement request 118 and initiate a pH measurement in the manner shown in FIG. 5. The pH modulated frequency signal 142 obtained from the periodic measurement is evaluated by the CPU 112 programming to ascertain whether the pH of the water contained in the tank is outside of two limit values stored in electronic memory 120. If the pH is outside of the pre-defined limits, an audible alarm CPU output 150 will activate the alarm speaker 28. A versatile alarm system includes a visible alarm CPU output 152 to activate the alarm light 30 when an aquarium owned by a hearing impaired person requires attention.

### Operation—FIGS. 1, 2, and 5

The manner of using the wireless monitor is to immerse the STA 15 into the aquarium water and place the side with the transparent window 14 against the transparent wall 16 of the tank. Holding the STA 15 against the interior surface of the wall 16 with one hand, the transparent window 14 in the RDA 33 is placed against the exterior surface of the wall 16 using the other hand. Sliding the RDA 33 or the STA 15 against their respective surfaces of the wall 16, the two windows 14 are brought into approximate line-of-sight alignment until the magnet 34 in each attract one another. When the magnetic attraction between the STA 15 and the RDA 33 is sufficient to hold them in place on the tank wall 16, they are released and rely on friction to maintain their position. When the wall 16 is sandwiched between the STA 15 and the RDA 33, the position of this invention can be adjusted as desired by grasping the RDA 33 and sliding it on the exterior surface of the wall 16. Held in place by magnetic attraction, the STA 15 will slide along the interior surface of the tank wall 16 and follow the movement to the desired wall 16 location for the wireless monitor. This makes it a simple process to sandwich the wall 16 with the STA 15 and the RDA 33 near the surface of the water and move it to a deeper location on the transparent wall 16.

To make a pH measurement, the water test button 22 is manually pushed. The RDA 33 will send a single light pulse 116 to the STA 15 that will activate the timer 122 and turn the pH measurement circuit power supply 108 on for a pre-determined amount of time. For that period of time, a train of frequency modulated infrared light pulses 140 are transmitted from the STA 15 to the RDA 33. The CPU 112 will sample the pH modulated frequency signal 142 for the time required to obtain an accurate average of its frequency. That frequency is converted to a digital pH value 144 that is then shown in the monitor display 20 as a numerical value of pH for a pre-determined amount of time.

To calibrate the pH sensor 6 or to adjust alarm set-points, there are numerous ways to indicate to the CPU 112 that such an action is desired. Simultaneously pressing the up arrow button 24 and the down arrow button 26, or the addition of specific buttons to the faceplate 32 are only two ways that can be employed. The specific mechanism by which the look-up table in electronic memory 120 that contains calibration constants and set-point pH values is updated is beyond the scope of the present invention. Because this invention is clearly described as dependent upon the CPU 112 and the electronic memory 120, the reader can see that the specificities of software programming are not necessary to provide full disclosure.

### Additional Embodiments

There are a number of water parameters that can be sensed using a probe similar to the pH sensor of this invention. Ions that are of interest to aquarium owners are reflected in the commercial availability of colorimetry kits that test for ammonia, nitrate, nitrite, hardness and alkalinity. All of the ions measured by the colorimetry kit can be measured by similar electrodes used to measure pH, and thus can be directly used by the wireless monitor. Dissolved oxygen sensors, conductivity cells for salinity, and temperature sensors such as a thermistor are also readily adapted to the wireless monitor for aquariums.

The preferred embodiment of this invention describes a single sensor, specifically for measuring pH. In practice, this invention can be embodied with multiple sensors. A second device such as a temperature sensor can easily be attached to the described transmitter circuit assembly and provide monitoring of yet another important water parameter for aquariums and the like.

The wireless monitor can be configured with a sensor for a fluid such as a gas, enabling this invention to be used to measure moisture, flammable or explosive gas levels, and oxygen in a closed container such as a glove-box.

Configured with a radiation sensor, this invention can be used for radioactive applications where the wireless monitor can be placed on a glove-box viewing window or the leaded glass of a radioactive waste storage chamber.

This invention as described is used on an aquarium having a transparent wall of glass, acrylic or the like. In the case of an opaque tank made of a material such as fiber-filled polypropylene or polyethylene, the infrared light used to convey the sensor information would not transmit through the wall. In such a case, this invention would be useful using another form of energy to transmit the pulses that initiate of a pH measurement and subsequent pH sensor output. Such forms of energy include, but are not limited to:
1. a fluctuating magnetic field for a tank wall material that does not form a Guassian shield, such as a fiber-filled thermoplastic or thermoset polymer, copper, and some stainless steels;
2. radio or microwave frequency radiation for a non-metallic tank wall where the conductivity of the liquid within does not significantly affect the signal strength; and
3. acoustic energy to transmit the sensor output through tank walls made of a material that interposes a Gaussian shield between the STA and the RDA.

The method by which this invention can be attached to the tank wall and maintain the location in which it was placed is shown to be the mutual attraction of two magnets in the preferred embodiment. This method works best when the wall thickness is less than approximately one half inch. For a wall that is significantly thicker, this invention is useful if the STA and the RDA are attached directly to the wall using a suction cup or similar device. In applications where there are large fish that could knock the STA off from the interior wall or other turbulent scenarios, it can be attached directly to the tank wall using an adhesive such as silicone or epoxy. When using the monitor in public places, permanent attachment of the RDA to the exterior wall of the tank may be required to prevent theft.

The present invention can be used on a container such as a bag made of polyethylene, polyethylene terephthalate (PET), or similar material.

The encapsulation with the potting material of the transmitter circuit assembly can be obviated using housing structures that incorporate rubber seals and the like.

The frequency modulated voltage pulses and subsequent frequency modulated light pulses can be configured in pattern conforming to a standard serial communication format such as RS-232 or similar.

The detachable sensor shown in the preferred embodiment can be incorporated directly into the STA if the operational life is considered permanent, such as a thermocouple, thermistor, or conductivity cell and the like.

This invention finds great usefulness when configured with access to the Internet or a wireless cellular phone network to send the measurement results of many tanks to a central monitoring location.

By storing the measurement results in electronic memory for later retrieval, this invention is useful in applications such as shipment of live aquatic specimens and other records of water fitness over time.

This invention can be configured in many shapes other than rectangular, including but not limited to circular, square, triangular, or an iconic shape such as an aquatic life form, logo or decorative representation.

### Advantages

From the description above, a number of advantages of this wireless electronic monitor for containers such as aquariums become evident:
1. An aquarium can be monitored around the clock for pH.
2. This invention generates an audible and visible alert if the pH of the water is outside of expected boundaries.
3. This invention is easy to install on the wall of a tank near the surface the water and can be moved to a deeper location without inserting the hand or arm into the water.
4. A pH dependent electrical signal gives the opportunity to use a CPU to manage sensor calibration, activate alarms, and store measurement results.
5. The wireless electronic monitor has a broader test range and finer resolution of measurement than colorimetry pH measurements.
6. This invention is simple to use and less intrusive for aquarium applications than laboratory and industrial pH monitoring equipment presently available.
7. Sandwiching the wall of a container such as a tank or aquarium permits this invention to operate in saltwater because the transmission medium is the wall material, not the liquid contained in the tank.

### CONCLUSIONS, RAMIFICATIONS, AND SCOPE

Accordingly, the reader will see that the wireless electronic monitor can be configured with a sensor other than for pH, can use two or more sensors together such as pH and temperature, and can be configured with a sensor for gases, vapors or radioactivity. Also, this invention can use forms of energy other than light to communicate sensor output, can also be attached to a container wall with suction generating devices or adhesive, can be configured with access to distributed communications-networks to monitor multiple tanks from a remote location, and can be configured to store periodic measurement results in the electronic memory to serve as a data logger. Additional embodiments use modulated light pulses that conform to a serial communication standard, integrate the sensor into the sense and transmit assembly (STA), and can have various shapes.

Although the description above contains many specificities, these should not be construed as limiting the scope of the invention but as merely providing illustrations of some of the presently preferred embodiments of this invention. While the invention has been described in connection with certain preferred embodiments, it is not intended to limit the scope of the invention to the particular forms set forth, but on the contrary, it is intended to cover such alternatives, modifications, and equivalents as may be included within the scope of the invention as defined by the claims.

I claim:

1. A sensor apparatus for a fluid within a container comprising:
(a) at least one sensor configured to sense a property of said fluid,
(b) a first device configured with said sensor disposed interior of said container immersed in said fluid therein,
(c) a second device disposed exterior of said container,
(d) a first means to dispose in combination said first device and said second device contiguous with and sandwiching a wall of said container,
(e) a second means in combination to transmit the output of said sensor from said first device to said second device using said wall as a transmission medium for a plurality of sequential pulses of energy, and
(f) a third means in combination of converting said plurality of sequential pulses of energy to an electronic representation and storing said representation in an electronic memory,
whereby said sensor system is wireless and obviates communicating the output of said sensor using said fluid as a transmission medium.

2. The sensor apparatus of claim 1 wherein magnets cause a clamp force sandwiching said wall with said first device and said second device.

3. The sensor apparatus of claim 1 wherein a plurality of suction devices are used to attach said first device and said second device to respective sides of said wall.

4. The sensor apparatus of claim 1 wherein said plurality of sequential pulses of energy are light.

5. The sensor apparatus of claim 1 wherein said plurality of sequential pulses of energy is an alternating magnetic field.

6. The sensor apparatus of claim 1 wherein said plurality of sequential pulses of energy are acoustic.

7. The sensor apparatus of claim 1 wherein said plurality of sequential pulses of energy are radio waves.

8. A method for communicating the output of a sensor from the interior to the exterior of a container comprising:
(a) representing the output of said sensor as a train of energy pulses,
(b) coupling said train of energy pulses with a first side of a wall of said container,
(c) detecting said train of energy pulses at a second side of said wall of said container,
(d) representing said train of energy pulses as the output of said sensor, and
(e) storing the represented output of said sensor in an electronic memory,
whereby the output of said sensor within said container communicates the output of said sensor to said electronic memory in a manner that is wireless and does not penetrate said wall of said container.

9. The method of claim 8 wherein said train of energy pulses are frequency modulated.

10. The method of claim 8 wherein said train of energy pulses are modulated conforming to a serial communication protocol.

11. A submersible transducer, comprising:
(a) a concave reservoir having an oblate surface configured with an opening,
(b) a transparent cover overlapping and contiguous with said opening and sealed waterproof,
(c) an annular magnet disposed such that the hole in the magnet is approximately aligned with said opening and contiguous with said transparent window,
(d) a substrate configured with a light source on a first side disposed such that said source of light is approximately centered within said hole and facing said transparent cover,
(e) a potting material filling said concave reservoir such that said substrate is encapsulated waterproof, a plurality of electrical connections to a second side of said substrate are accessible, and said light source is unobstructed,
(f) at least one sensor configured to measure a property of a liquid,
(g) a header formed about the electrical connection of said sensor such that electrical connection between said sensor and said second side of substrate is detachably made,
(h) an energy store, and
(i) a first means of urging an elastomer material against said potting material by said header to render the electrical connections of said sensor waterproof,
whereby said submersible transducer is placed within said liquid, said sensor detects said property, said substrate converts the output of said sensor into modulated pulses of light, and said light is projected outward through said transparent window.

12. Said concave reservoir of claim 11 wherein a feature disposed near said opening on said oblate surface facilitates aligned attachment of said transparent cover and said annular magnet with said opening.

13. Said potting material of claim 11 wherein a polyurethane material fills said concave reservoir.

14. Said potting material of claim 13 wherein a silicone rubber material fills said concave reservoir.

15. Said header of claim 11 wherein the electrical connection of said sensor and an ancillary circuit are molded together within a two part polyurethane material curing at near room temperature.

16. Said header of claim 11 wherein the electrical connection of said sensor and an ancillary circuit are molded together within a two part silicone rubber material curing at near room temperature.

17. Said first means of claim 11 wherein a rotating threaded fastener imparts the urging force.
